(19) United States
(12) Patent Application Publication
(10) Pub. No.: US 2025/0171378 A1
(43) Pub. Date: May 29, 2025

(54) AGRICULTURAL COMBINATION

(71) Applicants: UPL Corporation Limited, Port Louis (MU); UPL Europe LTD, Warrington Cheshire (GB)

(72) Inventors: Marin Virgilio VALDES, Saltillo, Coahuila (MX); Susana Solis GAONA, Saltillo, Coahuila (MX); Mario Ramon VILLARREAL, Saltillo, Coahuila (MX); Paola Leija MARTINEZ, Saltillo, Coahuila (MX); Paloma Santana GARCIA, Saltillo, Coahuila (MX); Maria De Lourdes DELGADO, Saltillo, Coahuila (MX)

(21) Appl. No.: 18/842,560

(22) PCT Filed: Feb. 28, 2023
(86) PCT No.: PCT/GB2023/050445

§ 371 Date: Aug. 29, 2024

(30) Foreign Application Priority Data
Mar. 1, 2022 (IN) 202211010932

(51) Int. Cl. C05G 3/80; A01C 21/00; B01J 20/26; C05F 11/02; C05G 5/30; C09K 17/32

(52) U.S. Cl. CPC C05G 3/80; B01J 20/264; C05F 11/02; C05G 5/37; C09K 17/32; A01C 21/00

(57) ABSTRACT

The present disclosure relates to an agricultural combination/composition. More particularly, the present disclosure relates to a granular agricultural composition comprising a plant fertilizer and a superabsorbent polymer. The present disclosure also relates to a process for preparing the agricultural composition and a method for conditioning the soil using the same.

### FIELD OF THE DISCLOSURE

The present disclosure relates to an agricultural combination/composition and a process for preparation of the same thereof. More particularly, the present disclosure relates to an agricultural composition comprising a plant fertilizer compound and a superabsorbent polymer. The present disclosure further relates to a method for conditioning the soil using the same.

### BACKGROUND OF THE DISCLOSURE

Different factors associated with soil are known to increase the nutrient availability in the soil, which in turn affect the plant productivity. Among these, one of the most significant factors is the soil microbial community, especially the rhizosphere, the phyllosphere and the endosphere. The rhizosphere is a biologically active zone of the soil surrounding the roots of plants and containing soil-borne microorganisms. Here, complex interactions occur between the roots, soil, and the microorganisms. Root exudates serve as substrates and signaling molecules for microbes, thus creating a complex relationship between plants and the soil microbiome. The phyllosphere is referred to as the aerial part of the plant above the ground, usually surface of leaves or surface of the root and shoot, which is considered as a habitat for microorganisms. The plant endosphere is the inner plant organs including the fruits and seeds, which are colonized by complex microbial communities and microorganisms. Soil is the ultimate source from which plants recruit beneficial microbes for the rhizosphere, phyllosphere and the endosphere. These plant microbes increase the nutrient use efficiency and thereby crop yield; they are also involved in enhancing resistance of the plants against insects, bacterial and fungal pathogens and even nematodes or viral infections. Each microorganism functions in coordination with the overall soil microbiome to influence the plant health and the crop productivity.

Furthermore, the persistent application of pesticides has long lasting and deleterious effects on the soil microbiome. It has been noted that most copper-based fungicides have a deleterious effect on the nitrogen-fixing bacteria present in the soil. Similarly, long-term application of organomercurials has negative effects on the cellulolytic fungal species. Carbendazim, a widely used, systemic, broad-spectrum benzimidazole fungicide, is highly toxic to Trichoderma harzianum, a fungus which also acts as a fungicide. It acts as a potent biocontrol agent against soil-borne fungal pathogens Fusarium, Pythium and Rhizoctonia. Fungicides also inhibit hyphal growth and root colonization by arbuscular mycorrhizal fungi. Even insecticides at field-recommended concentrations have undesirable effects on soil and rhizosphere microbiota. Intensive agricultural techniques and the lack of crop rotation impoverishes the population of beneficial soil microorganisms that assist in the assimilation of nutrients and thereby, the proper development of crops. Thus, the excessive application of herbicides, pesticides and fertilizers, heavy ploughing and tillage, and the failure to add organic matter back to the soil upon which the microbes feed has led to severe damage of the soil microbiome.

Additionally, organic matter in soil mitigates adverse effects of intense crop production techniques and promotes the development of beneficial microorganisms. Additional benefits of organic matter such as humic acids include conferring better soil structure, improved water retention in soil, increased cell wall permeability, increased crop production, decreased disease and infestation, and a decreased need for fertilizer and associated costs. However, due to modern farming methods, the humic acid content has become less abundant in today's agricultural and gardening soils. Therefore, it is imperative for organic matter to be replaced to restore a healthy soil, leading to healthy plants, and healthy crops.

Despite understanding the importance of soil microbiome, the diversity and complexity of the soil microbial communities make them incredibly difficult to manage. Many strategies do exist for managing soil microbes; they range from adding beneficial microbes (inoculants or commercial products) to suppressing harmful microbes (soil fumigation, soil steaming, anaerobic disinfestation, and solarization). However, these approaches range in cost, labor and equipment needs, scale of application, and measurable efficacy. Additionally, common crop management practices, such as tillage, crop rotation, cover cropping, and adding compost, manure, or mulch, often target other agronomic needs rather than influencing soil microbial communities. Therefore, the need of the hour is to have an emphasis on the integration of beneficial microbes into agriculture, which is likely to enhance the assimilation of nutrients in the soil and contribute to providing good quality agricultural produce in a sustainable manner by reducing the number of fertilizers, pesticides and herbicides being used. Therefore, it is of significance to establish and maintain a healthy soil microbiome.

### OBJECTIVES OF THE DISCLOSURE

It is a primary objective of the present disclosure to provide an agricultural composition for increasing plant growth by promoting microbes and activity in the soil.

It is another objective of the present disclosure to provide a method for increasing plant growth by promoting microbial populations and improving microbial activity in the soil.

It is yet another objective of the present disclosure to provide a method for growing seeds or seedlings.

It is yet another objective of the present disclosure to provide a method for conditioning the soil to improve crop yield and crop quality.

### SUMMARY OF THE DISCLOSURE

In one aspect, the present disclosure provides an agricultural composition comprising at least one plant fertilizer compound, a superabsorbent polymer and an agriculturally acceptable excipient.

In another aspect, the present disclosure provides an agricultural composition comprising at least one plant fertilizer compound, a superabsorbent polymer and an agriculturally acceptable excipient; wherein a weight ratio of the plant fertilizer compound to the superabsorbent polymer ranges from about 5:1 to about 20:1.

In yet another aspect, the present disclosure provides a granular agricultural composition comprising humic acid, starch-g-poly(2-propenamide-co-2-propenoic acid) potassium salt polymer and an agriculturally acceptable excipient; wherein a weight ratio of humic acid to starch-g-poly(2-propenamide-co-2-propenoic acid) potassium salt polymer ranges from about 5:1 to about 20:1.

In yet another aspect, the present disclosure also provides use of the agricultural composition according to the present disclosure for increasing plant growth by promoting microbial populations and improving microbial activity in the soil.

In yet another aspect, the present disclosure provides a method for increasing plant growth by promoting microbial populations and improving microbial activity in the soil by applying an effective amount of the present agricultural composition to the soil or the rhizosphere, wherein an increase in the population of the microbial populations is intended.

In one more aspect, the present disclosure provides a method for conditioning soil to improve crop yield and crop quality by applying an effective amount of the present agricultural composition to the soil or the rhizosphere, wherein an increase in the microbial populations is intended.

Additional features and advantages of the present disclosure will be apparent from the detailed description that follows, which illustrates by way of example, the most preferred features of the present disclosure which are not to be construed as limiting the scope of the disclosure described herein.

### BRIEF DESCRIPTION OF DRAWINGS

FIGS. 1a, 1b and 1c discloses the effect of different temperature(s) on the composition comprising superabsorbent polymer and humic acid.

### DETAILED DESCRIPTION OF THE DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a”, “an” and “the” include plural referents unless the content clearly dictates otherwise. The terms “preferred” and “preferably” refer to embodiments of the disclosure that may afford certain benefits, under certain circumstances.

As used herein, the terms “comprising”, “including”, “having”, “containing”, “involving”, and the like are to be understood to be open-ended i.e., to mean including but not limited to.

As used herein, the terms “about” or “approximately” are inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

The expression of various quantities in terms of “%” or “% w/v” or “% w/w” means the percentage by weight of the total solution or composition unless otherwise specified.

As used herein, the term “agricultural” is understood to denote an agricultural chemical such as pesticides, fungicides, insecticides, acaricides, herbicides, nematicides, plant growth regulators and can be used interchangeably.

The salts referred to herein are agriculturally acceptable salts. As used herein, an “agriculturally acceptable salt” means a salt which is acceptable for use in agricultural or horticultural use.

As used herein, the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” as used herein shall denote the vicinity of a desired crop in which control of the spread of phytopathogenic fungi or fungi like pathogen is desired. The locus includes the vicinity of desired crop plants wherein the phytopathogenic fungi or fungi like pathogen infection has either emerged or is most likely to emerge or is yet to emerge.

As used herein, the term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes, parts of plants. Germinated plants or young plants, which may be transplanted after germination or after emergence from the soil.

As used herein, the term “seed” embraces seeds and plant propagules of all kinds including but not limited to true seeds, seed pieces, suckers, corms, bulbs, fruit, tubers, grains, cuttings, cut shoots and the like and means in a preferred embodiment true seed.

As used herein, the term “soil” refers to any mixture of particulate surface material of the earth, whether or not it contains organic matter, and includes sand silt, clay and crushed rock such as decomposed granite, or any combination thereof.

As used herein, the term “sand” refers to any granular material formed by the disintegration of rocks to form particles smaller than gravel but coarser than silt. Sand may or may not include organic matter.

As used herein, the term “silt” refers to any unconsolidated sedimentary material with rock particles usually 1/20 mm or less in diameter and being generally smaller than sand but coarser than clay. Silt may or may not include organic matter.

As used herein, the term “clay” refers to any inorganic earth surface material that is plastic when moist but hard when fired and that is comprised primarily of hydrous aluminum silicates and/or other minerals, or substance having the properties of clay. Clay includes dry or wet materials and may or may not include organic matter.

As used herein, the term “organic binder” refers to any carrier that consists primarily of organic matter and that tends to bind soil particles together when mixed with soil, wetted and subsequently dried.

As used herein, the term “superabsorbent polymer (SAP)” refers to water swellable polymers which can absorb water many times their weight in an aqueous solution. Without wishing to be bound by theory, the term superabsorbent polymer also applies to polymer that absorbs water as well as de-sorbs the absorbed water. The superabsorbent polymer may be selected from but not limited to water-swellable or water absorbing or water-retentive polymers such as cross-linked polymers that swell without dissolving in the presence of water, and may, absorb at least 10, 100, 1000, or more times their weight in water.

As described herein, the term “increased yield” of an agricultural plant means that the yield of a product of the respective plant is increased by a measurable amount over the yield of the same product of the plant produced under the same conditions, but without the application of the compositions described herein.

As used herein, the term “g a.i./L” as used herein denotes the concentration of the respective active ingredient in “grams” present “per litre” of the composition.

As used herein, the term “g a.i./h” as used herein denotes the concentration of the respective active ingredient in “grams” applied “per hectare” of the crop field.

As used herein, the term “tank mix” refers to a formulation of more than one component in a tank mix formulation and intended to be applied onto plants with/without further dilution with water to make a mixture.

As used herein, the term “pre-mix” refers to a formulation of more than one component in a ready-mix formulation and intended to be applied onto plants with/without further dilution with water to make a mixture.

Each of the aspects described above may have one or more embodiments. Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

The inventors of the present disclosure have unexpectedly found that plant fertilizer compounds coated with a starch polymer improved soil quality with increased growth of microorganisms beneficial to plant growth in soil microbiota. Therefore, the inventors have coated solid plant fertilizer compounds with a starch polymer and have observed an increase in populations of microbes. The inventors have found that application of the present polymer-coated plant fertilizer composition enhances the organic matter in soil, thus resulting in a thriving microbiome with interacting bacteria, fungi and nematodes. The increase in such plant growth-promoting microbes eventually results in better absorption of water, nutrients, and minerals by plants causing improved growth parameters and an increased crop yield.

In an embodiment, the present disclosure provides an agricultural combination.

Accordingly in an embodiment, the present disclosure provides an agricultural combination comprising at least one plant fertilizer compound and a superabsorbent polymer.

According to an embodiment, the plant fertilizer compound is an organic fertilizer.

In an embodiment, the organic fertilizer is selected from humic acid substances. the humic acid substances are obtained from natural or synthetic sources. The natural sources of humic substances are, but not limited to, leonardite (naturally oxidized lignite), peat, compost, organic matter rich soil, and bog, marine and lake sediments. An artificial source may be, but not limited to, chemically oxidized coal and lignins.

In an embodiment, the humic acid substance is leonardite.

Accordingly in an embodiment, the superabsorbent polymer may be selected from synthetic, semi-synthetic, natural origin, degradable, non-degradable, hybrid or combinations thereof.

In an embodiment, the superabsorbent polymer may be a selected from, but not limited to, copolymer of acrylamide and sodium acrylate; hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2-propenamide-co-2-propanoic acid, mixed sodium and aluminum salts); starch-g-poly(2-propenamide-co-2-propanoic acid, potassium salt); poly(2-propenamide-co-2-propanoic acid, sodium salt); poly-2-propanoic acid, sodium salt; starch-g-poly(acrylonitrile) or poly(2-propenamide-co-sodium acrylate); starch/acrylonitrile copolymer; crosslinked copolymers of acrylamide and sodium acrylate; acrylamide/sodium polyacrylate crosslinked polymers; anionic polyacrylamide; starch grafted sodium polyacrylates; acrylic acid polymers, sodium salt; crosslinked potassium polyacrylate/polyacrylamide copolymers; sodium polyacrylate; superabsorbent polymer laminates and composites; partial sodium salt of crosslinked poly propenoic acid; potassium polyacrylate, lightly crosslinked; sodium polyacrylate, lightly crosslinked; sodium polyacrylates; poly(sodium acrylate) homopolymer; polyacrylamide polymers, carrageenan, agar, alginic acid, guar gums and its derivatives, and gellan gum; Specific superabsorbent polymers include crosslinked copolymer of acrylamide and potassium acrylate.

In an embodiment, the super absorbent polymer is starch-based super absorbent polymer.

In a preferred embodiment, the starch-based superabsorbent polymer is starch-g-poly(2-propenamide-co-2-propenoic acid) potassium salt or crosslinked polyacrylic acid potassium salt.

In a preferred embodiment, the superabsorbent polymer is starch-g-poly(2-propenamide-co-2-propenoic acid) potassium salt.

According to an embodiment, the present disclosure provides an agricultural combination comprising at least one plant fertilizer compound and a superabsorbent polymer; wherein a weight ratio of the plant fertilizer compound to the superabsorbent polymer ranges from about 1:1 to about 25:1.

In an embodiment, the weight ratio of the plant fertilizer compound to the superabsorbent polymer is selected from ratios comprising 1:1, 2:1, 3:1, 4:1, 5:1, 6:1, 7:1, 8:1, 9:1, 10:1, 11:1, 12:1, 13:1, 15:1, 16:1, 17:1, 18:1, 19:1, 20:1, 21:1, 22:1, 23:1, 24:1 and 25:1.

In an embodiment, the present disclosure provides an agricultural combination comprising at least one plant fertilizer compound and a superabsorbent polymer; wherein the weight ratio of the plant fertilizer compound to the superabsorbent polymer ranges from about 5:1 to about 20:1.

In an embodiment, the present disclosure provides an agricultural combination comprising at least one plant fertilizer compound and a superabsorbent polymer; wherein the weight ratio of the plant fertilizer compound to the superabsorbent polymer is about 15:1.

In a preferred embodiment, the present disclosure provides an agricultural combination comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 1:1 to about 25:1.

In a preferred embodiment, the present disclosure provides an agricultural combination comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 5:1 to about 20:1.

In a preferred embodiment, the present disclosure provides an agricultural combination comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer is about 15:1.

According to an embodiment, the present disclosure provides a coated granular fertilizer combination comprising at least one plant fertilizer compound and a superabsorbent polymer of a starch graft copolymer; wherein a weight ratio of the plant fertilizer compound to the superabsorbent polymer ranges from about 1:1 to about 25:1.

In a preferred embodiment, the present disclosure provides a coated granular fertilizer combination comprising at least one plant fertilizer compound and a superabsorbent polymer of a starch graft copolymer; wherein the weight ratio of the plant fertilizer compound to the superabsorbent polymer ranges from about 5:1 to about 20:1.

In a preferred embodiment, the present disclosure provides a coated granular fertilizer combination comprising at least one plant fertilizer compound and a superabsorbent polymer of a starch graft copolymer; wherein the weight ratio of the plant fertilizer compound to the superabsorbent polymer is about 15:1.

In a preferred embodiment, the present disclosure provides a coated granular fertilizer combination comprising humic acid and starch-g-poly(2-propenamide-co-2-propenoic acid) potassium salt polymer; wherein a weight ratio of humic acid to starch-g-poly(2-propenamide-co-2-propenoic acid) potassium salt polymer ranges from about 5:1 to about 20:1.

According to an embodiment, the present disclosure provides a coated granular fertilizer combination comprising at least one plant fertilizer compound in a solid form and at least one layer of a superabsorbent polymer of a starch graft copolymer.

In an embodiment, the present disclosure provides a coated granular fertilizer combination comprising at least one organic plant fertilizer compound in a solid form and at least one layer of a superabsorbent polymer; wherein the weight ratio of the organic plant fertilizer compound to the superabsorbent polymer ranges from about 1:1 to about 25:1.

In an embodiment, the present disclosure provides a coated granular fertilizer combination comprising at least one organic plant fertilizer compound in solid form and at least one layer of a superabsorbent polymer; wherein the weight ratio of the organic plant fertilizer compound to the superabsorbent polymer ranges from about 5:1 to about 20:1.

In an embodiment, the present disclosure provides a coated granular fertilizer combination comprising at least one organic plant fertilizer compound in solid form and at least one layer of a superabsorbent polymer; wherein the weight ratio of the organic plant fertilizer compound to the superabsorbent polymer is about 15:1.

In a preferred embodiment, the present disclosure provides a coated granular fertilizer combination comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 5:1 to about 20:1.

In another preferred embodiment, the present disclosure provides a coated granular fertilizer combination comprising humic acid and at least one layer of starch-g-poly(2-propenamide-co-2-propenoic acid) metal salt polymer; wherein a weight ratio of humic acid to starch-g-poly(2-propenamide-co-2-propenoic acid) metal salt polymer ranges from about 8:1 to about 18:1.

In yet another preferred embodiment, the present disclosure provides a coated granular fertilizer combination comprising humic acid and at least one layer of starch-g-poly(2-propenamide-co-2-propenoic acid) metal salt polymer, wherein the weight ratio of humic acid to starch-g-poly(2-propenamide-co-2-propenoic acid) metal salt polymer is about 15:1.

In a preferred embodiment, the present disclosure provides a coated granular fertilizer combination comprising humic acid and at least one layer of starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 5:1 to about 20:1.

In another preferred embodiment, the present disclosure provides a coated granular fertilizer combination comprising humic acid and at least one layer of starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 8:1 to about 18:1.

In a preferred embodiment, the present disclosure provides a coated granular fertilizer combination comprising humic acid and at least one layer of starch-g-poly(2-propenamide-co-2-propenoic acid) potassium salt polymer; wherein the weight ratio of humic acid to starch-g-poly(2-propenamide-co-2-propenoic acid) potassium salt polymer is about 15:1. According to an embodiment, the present disclosure provides an agricultural composition.

In an embodiment, the present disclosure provides an agricultural composition comprising at least one plant fertilizer compound and a superabsorbent polymer; wherein a weight ratio of the plant fertilizer compound to the superabsorbent polymer ranges from about 1:1 to about 25:1.

In an embodiment, the present disclosure provides an agricultural composition comprising at least one plant fertilizer compound and a superabsorbent polymer; wherein the weight ratio of the plant fertilizer compound to the superabsorbent polymer ranges from about 5:1 to about 20:1.

According to an embodiment, the plant fertilizer compound is an organic fertilizer compound.

In an embodiment, the organic fertilizer compound comprises humic acid, humates, fulvic acid, salicyclic acid, lignite, plant extracts, oil seed extracts, or combinations thereof.

In an embodiment, the organic fertilizer compound is humate.

In an embodiment, the organic fertilizer compound is fulvic acid.

In a preferred embodiment, the organic fertilizer compound is humic acid.

According to an embodiment, the superabsorbent polymer is starch-g-poly(2-propenamide-co-2-propenoic acid) metal salt polymer.

In a preferred embodiment, the superabsorbent polymer is starch-g-poly(2-propenamide-co-2-propenoic acid) potassium salt polymer.

In an embodiment, the present disclosure provides an agricultural composition comprising humic acid and starch-g-poly(2-propenamide-co-2-propenoic acid) potassium salt polymer; wherein a weight ratio of humic acid to starch-g-poly(2-propenamide-co-2-propenoic acid) potassium salt polymer ranges from about 1:1 to about 25:1.

In an embodiment, the present disclosure provides an agricultural composition comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer ranges from about 5:1 to about 20:1.

In an embodiment, the present disclosure provides an agricultural composition comprising humic acid and starch-g-poly(2-propenamide-co-2-propenoic acid) potassium salt polymer; wherein the weight ratio of humic acid to starch-g-poly(2-propenamide-co-2-propenoic acid) potassium salt polymer ranges is about 15:1.

According to an embodiment, the present disclosure provides an agricultural composition comprising at least one plant fertilizer compound, a superabsorbent polymer and at least one agriculturally acceptable excipient.

In an embodiment, the present disclosure provides an agricultural composition comprising at least one plant fertilizer compound, a superabsorbent polymer and at least one agriculturally acceptable excipient; wherein a weight ratio of the plant fertilizer compound to the superabsorbent polymer ranges from about 1:1 to about 25:1.

In an embodiment, the present disclosure provides an agricultural composition comprising at least one plant fertilizer compound, a superabsorbent polymer and at least one agriculturally acceptable excipient; wherein a weight ratio of humic acid to the superabsorbent polymer ranges from about 5:1 to about 20:1.

In an embodiment, the present disclosure provides an agricultural composition comprising humic acid, starch-g-poly(2-propenamide-co-2-propenoic acid) potassium salt polymer and at least one agriculturally acceptable excipient; wherein the weight ratio of the humic acid to starch-g-poly(2-propenamide-co-2-propenoic acid) potassium salt polymer ranges from about 5:1 to about 20:1.

In an embodiment, the present disclosure provides an agricultural composition comprising humic acid, starch-g-poly(2-propenamide-co-2-propenoic acid) potassium salt polymer and at least one agriculturally acceptable excipient; wherein the weight ratio of the humic acid to starch-g-poly(2-propenamide-co-2-propenoic acid) potassium salt polymer ranges from about 8:1 to about 18:1.

In an embodiment, the present disclosure provides an agricultural composition comprising humic acid, starch-g-poly(2-propenamide-co-2-propenoic acid) potassium salt polymer and at least one agriculturally acceptable excipient; wherein the weight ratio of the humic acid to starch-g-poly(2-propenamide-co-2-propenoic acid) potassium salt polymer ranges is about 15:1.

In an embodiment, the present disclosure provides an agricultural composition comprising at least one plant fertilizer compound, at least one layer of a superabsorbent polymer and at least one agriculturally acceptable excipient; wherein a weight ratio of the plant fertilizer compound to the superabsorbent polymer ranges from about 1:1 to about 25:1.

In an embodiment, the present disclosure provides an agricultural composition comprising at least one plant fertilizer compound, at least one layer of a superabsorbent polymer and at least one agriculturally acceptable excipient; wherein a weight ratio of the plant fertilizer compound to the superabsorbent polymer ranges from about 5:1 to about 20:1.

In an embodiment, the present disclosure provides an agricultural composition comprising at least one plant fertilizer compound, at least one layer of a superabsorbent polymer and at least one agriculturally acceptable excipient; wherein a weight ratio of the plant fertilizer compound to the superabsorbent polymer ranges is about 15:1.

According to an embodiment, the agriculturally acceptable excipient is selected from the group comprising binders, disintegrants, lubricants, wetting agent, dispersing agents, surfactants, anti-freezing agents, minerals, fillers, preservatives, inert oils and solvents. However, it should be appreciated that any other agriculturally acceptable excipients, as known to a person skilled in the art, may be used to serve its intended purpose.

In another embodiment, the inactive ingredients or binders comprise lactose powder, dibasic calcium phosphate, sucrose, corn (maize) starch, microcrystalline cellulose or modified cellulose, for example hydroxymethyl cellulose, polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides.

In another embodiment, the disintegrant hydrates readily in water and thereby improves the dispersion of the agricultural composition in any solvent. Some of the aforementioned binders, for example starch and cellulose, can also be used as a disintegrant.

In another embodiment, the lubricants comprise magnesium stearate, stearic acid (stearine), hydrogenated oil and sodium stearyl fumarate.

In another embodiment, the wetting agent may include any or a combination of sulfosuccinates, naphthalene sulfonates, sulfated esters, phosphate esters, sulfated alcohol and alkyl benzene sulfonates, or combinations thereof.

In another embodiment, the dispersing agents comprise polycarboxylates, naphthalene sulfonate condensates, phenol sulfonic acid condensates, lignosulfonates, methyl oleyl taurates and polyvinyl alcohols, or combinations thereof.

In another embodiment, the surfactant may include any or a combination of ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

In another embodiment, the anti-freezing agents may include any or a combination of ethylene glycol, propylene glycol, urea, glycerin and anti-freeze proteins, or combinations thereof.

In another embodiment, the minerals may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

In another embodiment, the fillers may include any or a combination of diatomaceous earth, kaolin, bentonite, precipitated silica, amorphous silica, attapulgite, and perlite, but not limited thereto.

In another embodiment, suitable preservatives are for example benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, benzoic acid, or combinations thereof.

In another embodiment, examples of inert oils comprise paraffin oil, mineral oil, soybean oil, castor oil, or any other such inert oil.

In another embodiment, examples of suitable solvents are water, oils of vegetable, or derivatives. In principle, solvent mixtures may also be used.

According to an embodiment, the agricultural composition comprises from about 25% w/w to about 99% w/w of the plant fertilizer compound of total weight of the agricultural composition.

In an embodiment, the agricultural composition comprises from about 60% w/w to about 98% w/w of the plant fertilizer compound of total weight of the agricultural composition.

In an embodiment, the agricultural composition comprises from about 70% w/w to about 95% w/w of the plant fertilizer compound of total weight of the agricultural composition.

In an embodiment, the agricultural composition comprises from about 80% w/w to about 92% w/w of the plant fertilizer compound of total weight of the agricultural composition.

In an embodiment, the agricultural composition comprises is about 92% w/w of the plant fertilizer compound of total weight of the agricultural composition.

According to an embodiment, the agricultural composition comprises from about 1% w/w to about 75% w/w of the superabsorbent polymer of total weight of the agricultural composition.

In an embodiment, the agricultural composition comprises from about 1% w/w to about 60% w/w of the superabsorbent polymer of total weight of the agricultural composition.

In an embodiment, the agricultural composition comprises from about 1% w/w to about 40% w/w of the superabsorbent polymer of total weight of the agricultural composition.

In an embodiment, the agricultural composition comprises from about 1% w/w to about 15% w/w of the superabsorbent polymer of total weight of the agricultural composition.

In an embodiment, the agricultural composition comprises from about 5% w/w to about 10% w/w of the superabsorbent polymer of total weight of the agricultural composition.

In an embodiment, the agricultural composition comprises is about 6% w/w of the superabsorbent polymer of total weight of the agricultural composition.

According to an embodiment, the agricultural composition comprises from about 1% w/w to about 99% w/w of the agriculturally acceptable excipients of total weight of the agricultural composition.

In an embodiment, the agricultural composition comprises from about 1% w/w to about 30% w/w of the agriculturally acceptable excipients of total weight of the agricultural composition.

Accordingly in an embodiment, the present disclosure provides an agricultural composition comprising:
from about 60% w/w to about 98% w/w of the plant fertilizer compound;
from about 1% w/w to about 40% w/w of the superabsorbent polymer; and
from about 1% w/w to about 30% w/w of the agriculturally acceptable excipient.

In an embodiment, the present disclosure provides an agricultural composition comprising:
from about 70% w/w to about 95% w/w of the plant fertilizer compound;
from about 1% w/w to about 15% w/w of the superabsorbent polymer; and from about 1% w/w to about 30% w/w of the agriculturally acceptable excipient.

In an embodiment, the present disclosure provides an agricultural composition comprising:
from about 80% w/w to about 92% w/w of the plant fertilizer compound;
from about 5% w/w to about 10% w/w of the superabsorbent polymer; and
from about 1% w/w to about 30% w/w of the agriculturally acceptable excipient.

In a preferred embodiment, the present disclosure provides an agricultural composition comprising:
about 92% w/w of the plant fertilizer compound;
about 6% w/w of the superabsorbent polymer; and
from about 1% w/w to about 30% w/w of the agriculturally acceptable excipient.

In a preferred embodiment, the present disclosure provides an agricultural composition comprising:
from about 60% w/w to about 98% w/w of humic acid;
from about 1% w/w to about 40% w/w of starch-g-poly(2-propenamide-co-2-propenoic acid) potassium salt polymer; and
from about 1% w/w to about 30% w/w of the agriculturally acceptable excipient.

In a preferred embodiment, the present disclosure provides an agricultural composition comprising:
from about 70% w/w to about 95% w/w of humic acid;
from about 1% w/w to about 15% w/w of starch-g-poly(2-propenamide-co-2-propenoic acid) potassium salt polymer; and
from about 1% w/w to about 30% w/w of the agriculturally acceptable excipient.

In a preferred embodiment, the present disclosure provides an agricultural composition comprising:
from about 80% w/w to about 92% w/w of humic acid;
from about 5% w/w to about 10% w/w of starch-g-poly(2-propenamide-co-2-propenoic acid) potassium salt polymer; and
from about 1% w/w to about 30% w/w of the agriculturally acceptable excipient.

In a preferred embodiment, the present disclosure provides an agricultural composition comprising:
about 92% w/w of humic acid;
about 6% w/w of starch-g-poly(2-propenamide-co-2-propenoic acid) potassium salt polymer; and
from about 1% w/w to about 30% w/w of the agriculturally acceptable excipient.

According to an embodiment, the agricultural composition of the present disclosure may be formulated in any of formulations such as solid formulation, aqueous formulation, aerosol, emulsifiable concentrate, wettable powder, soluble concentrate, soluble powder, suspension concentrate, spray concentrate, capsule suspension, water dispersible granule, granules, dusts, microgranule seed treatment formulation and the likes as known to persons skilled in the art.

In an embodiment, the agricultural composition of the present disclosure may be formulated in a form of a solid formulation.

In an embodiment, the agricultural composition may be present in granular form, or in the form of pellets or prills or any other form.

In an embodiment, the agricultural composition is selected from powder for dry soil application (DS), granule/soil applied (GR), controlled (slow or fast) release granules (CR), jambo balls or bags (bags in water soluble pouch), water soluble granule (SG), water dispersible granule (WG or WDG), or soil applied granules (SAG).

In an embodiment, the agricultural composition may be present in solid granular formulation.

In an embodiment, the agricultural composition may be present in coated granular formulation.

In an embodiment, the present disclosure provides granulated agricultural composition or agricultural composition comprising powdered or granulated superabsorbent polymer and a plant fertilizer compound.

In an embodiment, the present disclosure provides granulated agricultural composition or agricultural composition comprising powdered or granulated plant fertilizer compound and a superabsorbent polymer.

In an embodiment, the agricultural composition is formulated as a granulated composition comprising powdered or granulated humic acid and starch-g-poly(2-propenamide-co-2-propenoic acid) potassium salt polymer.

Accordingly in an embodiment, the present disclosure provides a solid composition comprising at least one plant fertilizer compound, a superabsorbent polymer and at least one agriculturally acceptable excipient.

In an embodiment, the present disclosure provides a granular composition comprising at least one plant fertilizer compound, a superabsorbent polymer and at least one agriculturally acceptable excipient.

In an embodiment, the present disclosure provides a coated granular composition comprising at least one plant fertilizer compound, a superabsorbent polymer and at least one agriculturally acceptable excipient.

In an embodiment, the present disclosure provides a coated granular composition comprising humic acid, starch-g-poly(2-propenamide-co-2-propenoic acid) potassium salt polymer and at least one agriculturally acceptable excipient.

In an embodiment, the present disclosure provides a coated granular composition comprising humic acid, starch-g-poly(2-propenamide-co-2-propenoic acid) potassium salt polymer and at least one agriculturally acceptable excipient; wherein a weight ratio of humic acid to starch-g-poly(2-propenamide-co-2-propenoic acid) potassium salt polymer ranges from about 1:1 to about 25:1.

In an embodiment, the present disclosure provides a coated granular composition comprising humic acid, starch-g-poly(2-propenamide-co-2-propenoic acid) potassium salt polymer and at least one agriculturally acceptable excipient; wherein a weight ratio of humic acid to starch-g-poly(2-propenamide-co-2-propenoic acid) potassium salt polymer ranges from about 5:1 to about 20:1.

In an embodiment, the present disclosure provides a coated granular composition comprising humic acid, starch-g-poly(2-propenamide-co-2-propenoic acid) potassium salt polymer and at least one agriculturally acceptable excipient; wherein a weight ratio of humic acid to starch-g-poly(2-propenamide-co-2-propenoic acid) potassium salt polymer ranges from about 8:1 to about 18:1.

In an embodiment, the present disclosure provides a coated granular composition comprising humic acid, starch-g-poly(2-propenamide-co-2-propenoic acid) potassium salt polymer and at least one agriculturally acceptable excipient; wherein a weight ratio of humic acid to starch-g-poly(2-propenamide-co-2-propenoic acid) potassium salt polymer ranges is about 15:1.

In another embodiment, the present disclosure provides a coated granular composition comprising at least one plant fertilizer compound, at least one layer of a superabsorbent polymer of a starch graft copolymer and at least one agriculturally acceptable excipient.

In another embodiment, the present disclosure provides a coated granular composition comprising at least one plant fertilizer compound, at least one layer of a superabsorbent polymer of a starch graft copolymer and at least one agriculturally acceptable excipient; wherein a weight ratio of plant fertilizer compound to starch graft copolymer ranges from about 1:1 to about 25:1.

In another embodiment, the present disclosure provides a coated granular composition comprising humic acid, at least one layer of a superabsorbent polymer of a starch graft copolymer and at least one agriculturally acceptable excipient; wherein a weight ratio of humic acid to starch graft copolymer ranges from about 1:1 to about 25:1.

According to an embodiment, the present disclosure provides an agricultural composition in a form of a tank mix or a pre-formulated (pre-mix)/ready-mix formulation.

In an embodiment, the present disclosure provides an agricultural composition in a form of a tank mix formulation.

In an embodiment, the present disclosure provides an agricultural composition in a form of a pre-formulated (pre-mix)/ready-mix formulation.

Accordingly in an embodiment, the present disclosure provides a pre-mix/ready-mix composition comprising at least one plant fertilizer compound, a superabsorbent polymer and at least one agriculturally acceptable excipient.

In in an embodiment, the present disclosure provides a pre-mix/ready-mix composition comprising humic acid, starch-g-poly(2-propenamide-co-2-propenoic acid) potassium salt polymer and at least one agriculturally acceptable excipient; wherein a weight ratio of humic acid to starch-g-poly(2-propenamide-co-2-propenoic acid) potassium salt polymer ranges from about 1:1 to about 25:1.

In yet another embodiment, the agricultural composition may be applied to the soil prior to emergence of the seedling (pre-emergence). Alternatively, the application of the agricultural composition may be after the emergence of the seedling (post-emergence).

In yet another embodiment, the agricultural composition may be applied as a foliar spray at different timings during crop development, with as many early applications (pre-emergence) or late (post-emergence) applications as required.

In yet another embodiment, the agricultural composition may be applied for increasing plant growth by promoting microbial populations and improving microbial activity in the soil.

In yet another embodiment, the agricultural composition may be applied for growing seeds or seedlings.

In yet another embodiment, the agricultural composition may be applied for conditioning the soil to improve crop yield and crop quality.

According to an embodiment, the present disclosure provides a soil amendment/conditioning composition comprising humic acid and starch-g-poly(2-propenamide-co-2-propenoic acid) potassium salt polymer, wherein a weight ratio of humic acid to starch-g-poly(2-propenamide-co-2-propenoic acid) potassium salt polymer ranges from about 1:1 to about 25:1.

In an embodiment, the present disclosure provides a soil amendment/conditioning composition comprising humic acid and starch-g-poly(2-propenamide-co-2-propenoic acid) potassium salt polymer, wherein the weight ratio of humic acid to starch-g-poly(2-propenamide-co-2-propenoic acid) potassium salt polymer ranges from about 5:1 to about 20:1.

In an embodiment, the present disclosure provides a soil amendment/conditioning composition comprising humic acid and starch-g-poly(2-propenamide-co-2-propenoic acid) potassium salt polymer, wherein the weight ratio of humic acid to starch-g-poly(2-propenamide-co-2-propenoic acid) potassium salt polymer is about 15:1.

In an embodiment, the present disclosure provides a plant growth-promoting microbial composition comprising humic acid and starch-g-poly(2-propenamide-co-2-propenoic acid) potassium salt polymer, wherein ratio of humic acid to starch-g-poly(2-propenamide-co-2-propenoic acid) metal salt ranges from about 5:1 to about 20:1.

In an embodiment, the present disclosure provides a plant growth-promoting microbial composition comprising humic acid and starch-g-poly(2-propenamide-co-2-propenoic acid) potassium salt polymer, wherein a ratio of humic acid to starch-g-poly(2-propenamide-co-2-propenoic acid) metal salt is about 15:1.

According to an embodiment, the superabsorbent polymer is coated onto the plant fertilizer compound.

In an embodiment, at least one layer of the superabsorbent polymer is coated onto the plant fertilizer compound.

In an embodiment, starch-g-poly(2-propenamide-co-2-propenoic acid) metal salt polymer is coated onto humic acid.

In an embodiment, starch-g-poly(2-propenamide-co-2-propenoic acid) potassium salt polymer is coated onto humic acid.

In an embodiment, at least one layer of starch-g-poly(2-propenamide-co-2-propenoic acid) potassium salt polymer is coated onto humic acid.

In an embodiment, at least one layer of starch-g-poly(2-propenamide-co-2-propenoic acid) potassium salt polymer is coated onto humic acid granules.

In an embodiment, at least one layer of starch copolymer graft is coated onto humic acid.

In an embodiment, at least one layer of starch copolymer graft is coated onto humic acid granules.

In an embodiment, the pH of the agricultural composition ranges from about 8.5 to about 10.5.

In an embodiment, the agricultural composition comprises additional nutrient sources such as conventional nitrogen (N), phosphorus (P), potassium (K), magnesium (Mg), sulphur (S), calcium (Ca), but not limited to, ammonium sulphate, urea, ammonium nitrate, diammonium phosphate, mono-ammonium phosphate, mono-potassium phosphate, potassium nitrate, potassium sulphate, calcium nitrate, magnesium sulphate, magnesium nitrate.

In an embodiment, the nutrient sources comprising N, P, K, Mg, S and/or Ca are present from about 1% w/w to about 30% w/w of total weight of the agricultural composition.

In an embodiment, the agricultural composition may also contain trace elements like boron (B), copper (Cu), iron (Fe), manganese (Mn), molybdenum (Mo), zinc (Zn). These trace elements may be provided in the composition in the form of carriers containing these elements, like for example salts, oxides, hydroxides, chelates and/or complexing agents. The trace elements are present up to about 5% w/w of total weight of the agricultural composition.

In an embodiment, the agricultural composition further comprises at least one component selected from the group comprising fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents and mixtures thereof.

According to an embodiment, the present disclosure provides use of an agricultural composition comprising at least one plant fertilizer compound and a superabsorbent polymer, for increasing plant growth by promoting microbial populations and improving microbial activity in the soil.

According to an embodiment, the present disclosure provides use of an agricultural composition comprising at least one plant fertilizer compound and a superabsorbent polymer, for growing seeds or seedlings.

According to an embodiment, the present disclosure provides use of an agricultural composition comprising at least one plant fertilizer compound and a superabsorbent polymer, for conditioning soil to improve crop yield and crop quality.

In a preferred embodiment, the present disclosure provides use of an agricultural composition for increasing plant growth, wherein the agricultural composition comprises at least one plant fertilizer compound, a superabsorbent polymer and at least one agriculturally acceptable excipient, wherein a weight ratio of plant fertilizer compound to superabsorbent polymer ranges from about 1:1 to about 25:1.

In a preferred embodiment, the present disclosure provides use of an agricultural composition for increasing plant growth, wherein the agricultural composition comprises humic acid, starch-g-poly(2-propenamide-co-2-propenoic acid) potassium salt polymer and at least one agriculturally acceptable excipient, wherein a weight ratio of plant fertilizer compound to superabsorbent polymer ranges from about 5:1 to about 20:1.

In a preferred embodiment, the present disclosure provides use of an agricultural composition for growing seeds or seedlings, wherein the agricultural composition comprises at least one plant fertilizer compound, a superabsorbent polymer and at least one agriculturally acceptable excipient, wherein a weight ratio of plant fertilizer compound to superabsorbent polymer ranges from about 1:1 to about 25:1.

In a preferred embodiment, the present disclosure provides use of an agricultural composition for growing seeds or seedlings, wherein the agricultural composition comprises humic acid, starch-g-poly(2-propenamide-co-2-propenoic acid) potassium salt polymer and at least one agriculturally acceptable excipient, wherein a weight ratio of plant fertilizer compound to superabsorbent polymer ranges from about 5:1 to about 20:1.

In a preferred embodiment, the present disclosure provides use of an agricultural composition for conditioning soil, wherein the agricultural composition comprises at least one plant fertilizer compound, a superabsorbent polymer and at least one agriculturally acceptable excipient, wherein a weight ratio of plant fertilizer compound to superabsorbent polymer ranges from about 1:1 to about 25:1.

In a preferred embodiment, the present disclosure provides use of an agricultural composition for conditioning soil, wherein the agricultural composition comprises humic acid, starch-g-poly(2-propenamide-co-2-propenoic acid) potassium salt polymer and at least one agriculturally acceptable excipient, wherein a weight ratio of plant fertilizer compound to superabsorbent polymer ranges from about 5:1 to about 20:1.

According to another embodiment, the agricultural composition may be applied to the plant, or a locus or a plant propagation material thereof.

In another embodiment, the agricultural composition may be used for foliar application, application to a ground, or to the soil, or to a plant, or a locus or a plant propagation material, or combinations thereof.

According to an embodiment, the present disclosure provides a process for preparing an agricultural composition comprising at least one plant fertilizer compound, a superabsorbent polymer and at least one agriculturally acceptable excipient;
wherein the process comprises adding the superabsorbent polymer and at least one agriculturally acceptable excipient to the plant fertilizer compound to prepare a mixture and heating the mixture to a temperature of about 120° C. to obtain the agricultural composition.

According to an embodiment, the present disclosure provides a process for preparing an agricultural composition comprising at least one plant fertilizer compound, a superabsorbent polymer and at least one agriculturally acceptable excipient;
wherein the process comprises adding the superabsorbent polymer and at least one agriculturally acceptable excipient to the plant fertilizer compound followed by addition of an inert oil to prepare a mixture and heating the mixture to a temperature of about 120° C. to obtain the agricultural composition.

In an embodiment, the present disclosure provides a process for preparing an agricultural composition comprising humic acid, starch-g-poly(2-propenamide-co-2-propenoic acid) potassium salt polymer and at least one agriculturally acceptable excipient;
wherein the process comprises adding starch-g-poly(2-propenamide-co-2-propenoic acid) potassium salt polymer and amorphous silica to humic acid followed by addition of paraffinic oil to prepare a mixture and heating the mixture to a temperature of about 120° C. to obtain the agricultural composition.

In an embodiment, the present disclosure provides a process for preparing a solid agricultural composition comprising humic acid, starch-g-poly(2-propenamide-co-2-propenoic acid) potassium salt polymer and at least one agriculturally acceptable excipient;
wherein the process comprises adding starch-g-poly(2-propenamide-co-2-propenoic acid) potassium salt polymer and amorphous silica to humic acid followed by addition of paraffinic oil to prepare a mixture and heating the mixture to a temperature of about 120° C. to obtain the solid agricultural composition.

In an embodiment, the present disclosure provides a process for preparing a granular composition comprising humic acid, starch-g-poly(2-propenamide-co-2-propenoic acid) potassium salt polymer and at least one agriculturally acceptable excipient;
wherein the process comprises adding starch-g-poly(2-propenamide-co-2-propenoic acid) potassium salt polymer and amorphous silica to humic acid followed by addition of paraffinic oil to prepare a mixture and heating the mixture to a temperature of about 120° C. to obtain the granular composition.

In an embodiment, the present disclosure provides a process for preparing a coated granular composition comprising humic acid, starch-g-poly(2-propenamide-co-2-propenoic acid) potassium salt polymer and at least one agriculturally acceptable excipient;
wherein the process comprises adding starch-g-poly(2-propenamide-co-2-propenoic acid) potassium salt polymer and amorphous silica to humic acid followed by addition of paraffinic oil to prepare a mixture and heating the mixture to a temperature of about 120° C. to obtain the coated granular composition.

In a preferred embodiment, the present disclosure provides a process for preparing a coated granular composition comprising humic acid, starch-g-poly(2-propenamide-co-2-propenoic acid) potassium salt polymer and at least one agriculturally acceptable excipient;
wherein the process comprises adding starch-g-poly(2-propenamide-co-2-propenoic acid) potassium salt polymer and amorphous silica to humic acid followed by addition of mineral oil to prepare a mixture and heating the mixture to a temperature of about 120° C. to obtain the coated granular composition.

According to an embodiment, the present disclosure provides a method for increasing plant growth by promoting microbial populations and improving microbial activity in the soil, the method comprising applying an effective amount of an agricultural composition comprising at least one plant fertilizer compound and a superabsorbent polymer; wherein a weight ratio of the superabsorbent polymer to the superabsorbent polymer ranges from about 5:1 to about 20:1.

According to an embodiment, the present disclosure provides a method for increasing plant growth by promoting microbial populations and improving microbial activity in the soil, the method comprising applying an effective amount of a coated granular agricultural composition comprising humic acid and starch-g-poly(2-propenamide-co-2-propenoic acid) metal salt polymer, wherein starch-g-poly(2-propenamide-co-2-propenoic acid) metal salt polymer is coated onto humic acid and a weight ratio of humic acid to starch-g-poly(2-propenamide-co-2-propenoic acid) metal salt polymer ranges from about 1:1 to about 25:1.

In an embodiment, the present disclosure provides a method for increasing plant growth by promoting microbial populations and improving microbial activity in the soil, the method comprising applying an effective amount of a coated granular agricultural composition comprising humic acid and starch-g-poly(2-propenamide-co-2-propenoic acid) metal salt polymer, wherein starch-g-poly(2-propenamide-co-2-propenoic acid) metal salt polymer is coated onto humic acid and a weight ratio of humic acid to starch-g-poly(2-propenamide-co-2-propenoic acid) metal salt polymer ranges from about 5:1 to about 20:1.

In an embodiment, the present disclosure provides a method for increasing plant growth by promoting microbial populations and improving microbial activity in the soil, the method comprising applying an effective amount of a coated granular agricultural composition comprising humic acid and starch-g-poly(2-propenamide-co-2-propenoic acid) metal salt polymer, wherein starch-g-poly(2-propenamide-co-2-propenoic acid) metal salt polymer is coated onto humic acid and a weight ratio of humic acid to starch-g-poly(2-propenamide-co-2-propenoic acid) metal salt polymer is about 15:1.

In an embodiment, the present disclosure provides a method for increasing plant growth by promoting microbial populations and improving microbial activity in the soil, the method comprising applying an effective amount of a coated granular agricultural composition comprising humic acid and starch-g-poly(2-propenamide-co-2-propenoic acid) potassium salt polymer, wherein starch-g-poly(2-propenamide-co-2-propenoic acid) potassium salt polymer is coated onto humic acid and a weight ratio of humic acid to starch-g-poly(2-propenamide-co-2-propenoic acid) metal salt polymer is about 15:1.

According to an embodiment, the composition according to the disclosure is applied from a pre-dosage device, a knapsack sprayer, a spray tank, a spray plane, or an irrigation system. Typically, the agricultural composition is made up with water, buffer, and/or further auxiliaries to the desired application concentration and the ready-to-use spray liquor or the agricultural composition according to the disclosure is thus obtained.

In an embodiment, the present disclosure provides method for increasing plant growth by promoting microbial populations selected from rhizobacteria, actinomycete, fungus, arbuscular mycorrhizal fungi and endophytes.

In a preferred embodiment, the present disclosure provides method for increasing plant growth by promoting microbial populations selected from symbiotic nitrogen-fixing bacteria include the cyanobacteria of the genera Rhizobium, Bradyrhizobium, Azorhizobium, Allorhizobium, Sinorhizobium and Mesorhizobium, free-living nitrogen-fixing bacteria or associative nitrogen fixers, for example bacteria belonging to the species Azospirillum, Enterobacter, Klebsiella and Pseudomonas.

In an embodiment, the present disclosure provides method for increasing plant growth by promoting microbial populations selected from fungi comprising Trichoderma harzianum, T. nunbergii, T. viride, T. Longibrachiatum, T. koningiopsis, T. asperellum, T. stromaticum, Paecilomyces lilacinus, P. fumosoroseus, Isaria fumosorosea, Pochonia chlamydosporia, or mixtures thereof.

In an embodiment, the present disclosure provides method for increasing plant growth by promoting microbial populations selected from fungi comprising Trichoderma harzianum, T. nunbergii, T. viride, T. Longibrachiatum, T. koningiopsis, T. asperellum, T. stromaticum, Paecilomyces lilacinus, P. fumosoroseus, Isariafumosorosea, Pochonia chlamydosporia.

In an embodiment, the present disclosure provides method for increasing plant growth by promoting microbial populations selected from bacteria comprising Bacillus firmus, Bacillus amyloliquefaciens, Bacillus subtilis, Bacillus lichenformi, Bacillus methylotrophicus, Bacillus velezensis, Pasteuria nishizawae and Chromobacterium subtsugae.

In another embodiment, the solid agricultural composition is safely and conveniently applied to young plants or seeds in a dry form or the soil. This dry form is generally a granular carrier and facilitates the application of said composition in conjunction with other agrochemicals which are being applied concurrently. The dry agricultural composition can be added to other agrochemicals, such as but not limited to pesticides, herbicides, etc., which are either in aqueous form or dry form. It is preferable that the solid agricultural composition may be added to other agrochemicals in the dry form.

In one embodiment, the present disclosure provides a method for increasing plant growth by promoting microbial populations and improving microbial activity in soil by applying an effective amount of the present composition to the soil or rhizosphere, wherein an increase in the population of said microbial populations is intended.

In one embodiment, the present disclosure provides a method for increasing plant growth by promoting microbial populations and improving microbial activity in soil, wherein an effective amount of the present composition is applied from about 10 kg/ha to about 250 kg/ha to the soil or rhizosphere, wherein an increase in the population of said microbial populations is intended.

In one embodiment, the present disclosure provides a method for increasing plant growth by promoting microbial populations and improving microbial activity in soil, wherein an effective amount of the present composition is applied from about 50 kg/ha to about 200 kg/ha to the soil or rhizosphere, wherein an increase in the population of said microbial populations is intended.

In one preferred embodiment, the present disclosure provides a method for increasing plant growth by promoting microbial populations and improving microbial activity in soil, wherein an effective amount of the present composition is applied in a range of about 100 kg/ha to the soil or rhizosphere, wherein an increase in the microbial population is intended.

In one more embodiment, the present disclosure provides a method for conditioning soil to improve crop yield and quality by applying an effective amount of the present composition to the soil or rhizosphere, wherein an increase in the microbial populations intended.

In one more embodiment, the present disclosure provides a method for conditioning soil to improve crop yield and quality by applying an effective amount of the present composition ranging from about 50 kg/ha to about 200 kg/ha to the soil or rhizosphere, wherein an increase in the microbial population is intended.

In one more embodiment, the present disclosure provides a method for conditioning soil to improve crop yield and quality by applying an effective amount of the present composition of about 100 kg/ha to the soil or rhizosphere, wherein an increase in the microbial population is intended.

In another embodiment, the present disclosure provides a method for increasing plant growth by promoting microbial populations and improving microbial activity in soil, wherein the agricultural composition is applied in a range from about 10 g a.i./ha to about 3000 g a.i./ha.

In another embodiment, the present disclosure provides a method for increasing plant growth by promoting microbial populations and improving microbial activity in soil, wherein the agricultural composition is applied in a range from about 10 g a.i./ha to about 1500 g a.i./ha.

In another embodiment, the present disclosure provides a method for increasing plant growth by promoting microbial populations and improving microbial activity in soil, wherein the agricultural composition is applied in a range from about 10 g a.i./ha to about 500 g a.i./ha.

In another embodiment, the present disclosure provides a method for increasing plant growth by promoting microbial populations and improving microbial activity in soil, wherein the agricultural composition is applied in a range from about 50 g a.i./ha to about 450 g a.i./ha.

In another embodiment, the present disclosure provides a method for increasing plant growth by promoting microbial populations and improving microbial activity in soil, wherein the agricultural composition is applied in a range from about 100 g a.i./ha to about 400 g a.i./ha.

In another embodiment, the present disclosure provides a method for conditioning soil to improve crop yield and quality, wherein the agricultural composition is applied in a range from about 10 g a.i./ha to about 3000 g a.i./ha.

In another embodiment, the present disclosure provides a method for conditioning soil to improve crop yield and quality, wherein the agricultural composition is applied in a range from about 10 g a.i./ha to about 1500 g a.i./ha.

In another embodiment, the present disclosure provides a method for conditioning soil to improve crop yield and quality, wherein the agricultural composition is applied in a range from about 10 g a.i./ha to about 500 g a.i./ha.

In another embodiment, the present disclosure provides a method for conditioning soil to improve crop yield and quality, wherein the agricultural composition is applied in a range from about 50 g a.i./ha to about 450 g a.i./ha.

In another embodiment, the present disclosure provides a method for conditioning soil to improve crop yield and quality, wherein the agricultural composition is applied in a range from about 100 g a.i./ha to about 400 g a.i./ha.

According to an embodiment, the various components of the granular agricultural composition may be used individually or already partially or completely mixed with one another to prepare the composition. It is also possible for the components to be separately packaged and used as a component in a kit of parts.

In one embodiment, the kits may include one or more of the components that are used to prepare a granular agricultural composition. For examples, the kits may include active ingredients and/or agriculturally acceptable excipients. One or more of the components may already be combined together or pre-formulated.

According to an embodiment of the present disclosure, a kit comprising a granular agricultural composition is provided. The kit comprises a plurality of components, including at least one of the ingredients of the agricultural composition of the present disclosure.

In one embodiment of the present disclosure, the kit includes at least one, or all of components needed to prepare the agricultural composition. For example, the kit may include at least one plant fertilizer compound and a superabsorbent polymer.

One or more of the components may already be combined together or pre-formulated. In those embodiments where more than two components are provided in a kit, the components may already be combined and as such are packaged in a single container such as a vial, bottle, can, pouch, bag and/or canister. In other embodiments, two or more components of a kit may be packaged separate from one another, i.e., they are not pre-formulated. As such, a kit may include one or more separate containers such as vials, cans, bottles, pouches, bags and/or canisters, each container containing a separate component of the agricultural composition.

In both forms, an individual component of the kit may be applied separate from or together with the other components of the kit or as a component of a combination or a composition.

The disclosure also provides a kit comprising agricultural composition for improving plant growth or for conditioning soil and instructions for use. The instructions for use typically comprise instructions for the application of the agricultural composition to a plant, or a locus, or a plant propagation material thereof.

According to an embodiment, the kit of parts comprises:
(a) at least one plant fertilizer compound;
(b) a superabsorbent polymer; and
(c) at least one agriculturally acceptable excipient
   and optionally further comprises:
(d) instructions for use.

In a preferred embodiment, the kit of parts comprises:
(a) humic acid;
(b) starch-g-poly(2-propenamide-co-2-propenoic acid) metal salt polymer; and
(c) at least one agriculturally acceptable excipient;
   and optionally further comprises:
(d) instructions for use.

In a preferred embodiment, the kit of parts comprises:
(e) humic acid;
(f) starch-g-poly(2-propenamide-co-2-propenoic acid) potassium salt polymer; and
(g) at least one agriculturally acceptable excipient;
   and optionally further comprises:
(h) instructions for use.

According to an embodiment of the present disclosure, the agricultural composition of the present disclosure is stable, over time and at various temperatures.

According to an embodiment of the present disclosure, the agricultural composition of the present disclosure, when heated up to a temperature of about 45° C. and above helps to avoid formation of clusters in the agricultural composition.

In an embodiment of the present disclosure, the agricultural composition of the present disclosure, when heated up to a temperature of at least about 45° C. helps to avoid formation of clusters in the agricultural composition.

In an embodiment of the present disclosure, the agricultural composition preferably retains its physical integrity during handling and spreading, and, upon broadcasting, typically releases the active ingredients when contacting wet soil, irrigation water, or rainfall hits the broadcasting granules.

The present agricultural combination or composition is synergistic and effective in increasing plant growth by promoting microbial populations and improving microbial activity in soil. The agricultural combination or composition also provides soil conditioning to improve crop yield and crop quality.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure.

It will be understood that the specification and examples are illustrative but not limitative of the present disclosure and that other embodiments within the spirit and scope of the disclosure will suggest themselves to those skilled in the art. Other embodiments can be practiced that are also within the scope of the present disclosure. The following examples illustrate the disclosure, but by no means intend to limit the scope of the claims.

### EXAMPLES

### Example 1: Composition Comprising Humic Acid and Superabsorbent Polymer

| | Concentration |
|---|---|
| Ingredients | % (w/w) |
| Humic acid | 92 |
| Starch-g-poly(2-propenamide- | 6 |
| co-2-propenoic acid) | |
| potassium salt polymer | |
| Mineral oil | 0.5 |
| Amorphous silica | Q.S. |
| Total | 100 |

### Example 2: Process for Preparation of the Agricultural Formulation

A sprinkler deposit was filled with 0.5 Liter water. The plant fertilizer compound of humic acid (40 kg) was loaded onto a stirring plate, operated at 20 rpm. Water was sprinkled at a rate of 8 rpm for wetting the plant fertilizer compound. In a separate container (206 kg of 6%) starch-g-poly(2-propenamide-co-2-propenoic acid) potassium salt polymer was mixed with (250 gm) amorphous silica. This mixture was added to humic acid till the entire mixture appeared to be dry. To avoid formation of aggregates/clusters, minimal amounts of amorphous silica was added when necessary. After addition of the polymer mixture to the stirring plate, (250 gm) paraffinic oil was added. The heating of the stirring plate was switched on with the air temperature set to 120° C. and fan speed at 1450 rpm. The temperature in the chamber was set until to 55° C.

### Example 3: Efficacy Data of Composition of Example 1

In Styrofoam pots with a capacity of 375 ml, 200 gm of soil was placed, with the treatment described below, and 1 ml of Trichoderma harzianum at 4.01×10⁵ cfu/ml was applied. They were placed in a climatic chamber at 30° C. with 38% of RH for 7 days. The soil was kept wet by spraying purified water with atomizer. After this time 1 g of sample was taken and placed in a test tube with 10 ml sterile water. The microbial colony count was performed in a Neubauer's chamber under a microscope. The results have been disclosed in Table 2.

TABLE 2
Efficacy results of Example 1

| | | Rate | Rate | Colony count |
|---|---|---|---|---|
| No. | Treatments | (kg/ha) | (gm/pot) | cfu/ml |
| T₀ | Untreated | — | 0 | 4.02 × 10⁵ |
| T₁ | Composition as in Example 1 | 100 | 0.0286 | 7.27 × 10⁵ |
| T₂ | Humic acid | 94 | 0.0269 | 2.33 × 10⁵ |
| T₃ | Superabsorbent polymer | 6 | 0.0017 | 5.04 × 10⁵ |
| | (Starch-g-poly(2- | | | |
| | propenamide-co-2-propenoic | | | |
| | acid) potassium salt polymer) | | | |

The composition of Example 1 comprising humic acid and starch-g-poly(2-propenamide-co-2-propenoic acid) potassium salt polymer increased microbial populations in soil, thus aiding in enhancing the organic matter in soil.

### Example 4: Stability Data of Composition of Example 1

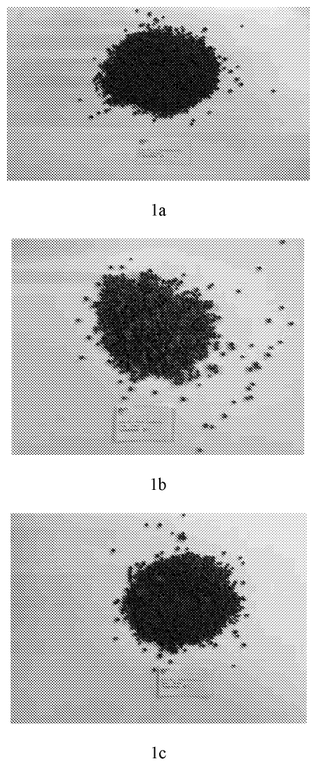

The composition of Example 1 was heated from room temperature to a temperature of about 45° C. Temperature was monitored during the process and a sample was taken every time the temperature increased by 10° C. It was observed that the composition of Example 1 formed clusters easily, however, the clusters disappeared once the sample was heated up to about 45° C. Therefore, the temperature of about 45° C. helped to avoid the formation of clusters in the composition of Example 1. This has been disclosed in FIGS. 1a to 1c.

What is claimed is:

1. An agricultural composition comprising:
at least one plant fertilizer compound;
a superabsorbent polymer; and
at least one agriculturally acceptable excipient;
wherein a weight ratio of the at least one plant fertilizer compound to the superabsorbent polymer ranges from 5:1 to 20:1.

2. The composition as claimed in claim 1, wherein the plant fertilizer compound is an organic plant fertilizer comprising humic acid, humates, fulvic acid, salicyclic acid, lignite, plant extracts, oil seed extracts, or combinations thereof.

3. The composition as claimed in claim 2, wherein the plant fertilizer compound is humic acid.

4. The composition as claimed in claim 1, wherein the superabsorbent polymer is starch-g-poly(2-propenamide-co-2-propenoic acid) potassium salt polymer.

5. The composition as claimed in claim 1, wherein the at least one agriculturally acceptable excipient is selected from the group consisting of binders, disintegrants, lubricants, wetting agent, dispersing agents, surfactants, anti-freezing agents, minerals, fillers, preservatives, inert oils and solvents.

6. The composition as claimed in claim 1, wherein the composition comprises from 60% w/w to 98% w/w of the at least one plant fertilizer compound based on a total weight of the agricultural composition.

7. The composition as claimed in claim 1, wherein the agricultural composition comprises from 1% w/w to 40% w/w of the superabsorbent polymer based on a total weight of the agricultural composition.

8. The composition as claimed in claim 1, wherein the agricultural composition comprises from 1% w/w to 30% w/w of the agriculturally acceptable excipient based on a total weight of the agricultural composition.

9. The composition as claimed in claim 1, wherein at least one layer of the superabsorbent polymer is coated onto the at least one plant fertilizer compound.

10. The composition as claimed in claim 1, wherein the composition is in a form of a pre-mix/ready-mix formulation.

11. The composition as claimed in claim 1 comprising:
humic acid;
starch-g-poly(2-propenamide-co-2-propenoic acid) potassium salt polymer; and
at least one agriculturally acceptable excipient;
wherein a weight ratio of the humic acid to the starch-g-poly(2-propenamide-co-2-propenoic acid) potassium salt polymer ranges from 5:1 to 20:1, and
wherein the agricultural composition is a coated granular composition.

12. (canceled)

13. A process for preparing an agricultural composition comprising:
at least one plant fertilizer compound;
a superabsorbent polymer; and
at least one agriculturally acceptable excipient;
wherein the process comprises:
adding the superabsorbent polymer and the at least one agriculturally acceptable excipient to the at least one plant fertilizer compound to form a mixture; and
heating the mixture to a temperature of about 120° C. to obtain the agricultural composition.

14. A method for increasing plant growth by promoting microbial populations and improving microbial activity in soil, the method comprising:
applying an effective amount of an agricultural composition comprising at least one plant fertilizer compound and a superabsorbent polymer;
wherein a weight ratio of the at least one plant fertilizer compound to the superabsorbent polymer ranges from 5:1 to 20:1.

15. The method as claimed in claim 14, wherein the composition is applied from 10 kg/ha to 250 kg/ha to the soil to provide an increase in microbial population.
